(19) United States
(12) Patent Application Publication
(10) Pub. No.: US 2025/0093314 A1
(43) Pub. Date: Mar. 20, 2025

(54) PRINTER ACTIVATABLE ENVIRONMENTAL SENSING THROUGH CHEMICAL ENCAPSULATION

(71) Applicant: Temptime Corporation, Morris Plains, NJ (US)

(72) Inventors: Eric W. LIBERATO, Pequannock, NJ (US); Brian S. HUFFMAN, Belle Mead, NJ (US); Anthony J. CECCHIN, Kildeer, IL (US); Mohannad ABDO, Clifton, NJ (US); Gene A. HOFER, Lake Zurich, IL (US)

(73) Assignee: Temptime Corporation, Morris Plains, NJ (US)

(21) Appl. No.: 18/369,498

(22) Filed: Sep. 18, 2023

(51) Int. Cl. G01N 31/22; B41M 5/50

(52) U.S. Cl. CPC G01N 31/22; B41M 5/502

(57) ABSTRACT

Printer activatable environmental sensing through chemical encapsulation are disclosed herein. An example activatable environmental sensor print medium includes a substrate, an environmental indicator material configured to respond to a predetermined environmental stimulus, and a plurality of microcapsules on or embedded in the substrate. The microcapsules contain the environmental indicator material and are configured to respond to at least one of an activation heat and an activation pressure by allowing the environmental indicator material to be released from the microcapsules. The environmental indicator material, after being released from the microcapsules, is configured to respond to exposure to the predetermined environmental stimulus by causing a detectable response.

### BACKGROUND

Perishable products including pharmaceuticals, food products, biologics, which may become unfit or unsafe for use after a certain length of time, or after exposure to various environmental conditions such as high temperature, radiation, UV or light exposure, oxygen exposure, freezing, thawing, or simply the passage of time, or the combination of multiple conditions, such as cumulative excess heat exposure over time. It is desirable to include environmental exposure indicators on such perishable products, or on or in their containers or packaging, in order to detect when products are either unfit for use, or approaching the end of their useful life.

Many indicators are irreversible, or at least have strong hysteresis effects, so that they provide a reliable view of historical exposure to environmental conditions. For example, an indicator might change color when temperature exceeded a threshold and maintain that changed color even after the temperature returned below the threshold, so that someone inspecting the indicator would be informed that the product had been exposed to the excessive temperature. Particularly for sensitive indicators, or indicator materials intended to have a long shelf life, it is desirable that the indicators remain inactive until they are incorporated in a printed label, and/or actually paired with a product that is entering the supply chain or moving into a different phase of the supply chain. Having an indicator which is inactive until a desired time may avoid the need to carefully control the environment in which the indicator is stored prior to activation. In a conventional indicator that does not have an activation, the indicator may need to be stored in highly controlled conditions prior to deployment with a product. For example, a cumulative heat indicator might be stored prior to being paired with a product in a deep freeze; a threshold indicator configured to detect heating above refrigeration temperatures would need to consistently be stored in a refrigerated environment prior to deployment; a sensitive humidity detector would need to be stored in controlled dry conditions. Accordingly, indicators which require an express action to “activate” the indicator and cause it to begin to operate are desirable for many applications. Prior “activatable” environmental indicators have included, for example, indicators with two chemical components, whose reaction controls the indicator process, which are provided separately and then are brought into contact using a physical connection. One example is the Safe-T-Vue® indicator from Zebra Technologies which include an indicator material in a separate reservoirs in a clamshell structure that is folded together to activate the device. A similar structure could be used to separate a two reactants in an indicator relying on a controlled reaction to produce a color change, where the activation brings the reactants into potential contact with other, and to react after a predetermined environmental exposure occurs. Another example is providing reactants in two films that are affixed to each other, e.g., with an adhesive, when the indicator is activated, such as the indicators described in U.S. Pat. No. 6,544,925 to Prusik et al. Other examples include indicators with a removable film barrier that can be withdrawn, e.g., by manually pulling it out, from between the two chemical components.

Thermal printers, which use high temperature print heads to change the color of special printable media, are ubiquitous in the supply chains of many industries. The present disclosure describes activatable indicators that are may be optimized for use in the existing thermal printing ecosystem.

### SUMMARY

Disclosed herein are activatable environmental sensor print media for providing an indication of the historical exposure of the activatable environmental sensor print media to a predetermined environmental stimulus after an activation event.

In an embodiment, the present disclosure includes an activatable environmental sensor print medium comprising a substrate, an environmental indicator material configured to respond to a predetermined environmental stimulus, and a plurality of microcapsules on or embedded in the substrate containing the environmental indicator material. The microcapsules are configured to respond to at least one of an activation heat or an activation pressure by allowing the environmental indicator material to be released from the microcapsules. The environmental indicator material, after being released from the microcapsules, is configured to respond to exposure to the predetermined environmental stimulus by causing a detectable response.

In another aspect of the present disclosure, which may be used in combination with any other aspect or combination of aspects listed herein, the detectable response is selected from a group consisting of a color state change, a change in transparency, a change in hue, a change in an electrical property, a change in conductivity, a change in capacitance, movement of the environmental indicator material along the substrate, and combinations thereof.

In another aspect of the present disclosure, which may be used in combination with any other aspect or combination of aspects listed herein, the environmental indicator material is configured to respond to exposure to the predetermined environmental stimulus by migrating along the substrate.

In another aspect of the present disclosure, which may be used in combination with any other aspect or combination of aspects listed herein, the environmental indicator material further comprises a meltable solid configured to melt in response to a predetermined temperature above a threshold, forming a liquid that migrates along the substrate for at least a predetermined distance when remaining at a temperature above the threshold for at least a predetermined time period.

In another aspect of the present disclosure, which may be used in combination with any other aspect or combination of aspects listed herein, the environmental indicator material further includes a colorant that migrates together with the liquid.

In another aspect of the present disclosure, which may be used in combination with any other aspect or combination of aspects listed herein, the activatable environmental sensor print medium further comprises a wick on or in the substrate, and is positioned to allow the released environmental indicator material and the colorant to migrate along the wick.

In another aspect of the present disclosure, which may be used in combination with any other aspect or combination of aspects listed herein, the environmental indicator material comprises a gel configured to, in response to a predetermined temperature above a threshold, change viscosity causing the gel to migrate along the substrate for at least a predetermined distance when remaining at a temperature above the threshold for at least a predetermined time period.

In another aspect of the present disclosure, which may be used in combination with any other aspect or combination of aspects listed herein, the environmental indicator material further includes a colorant that migrates together with the gel.

In another aspect of the present disclosure, which may be used in combination with any other aspect or combination of aspects listed herein, the activatable environmental sensor print medium further comprises a wick on or in the substrate, and is positioned to allow the released environmental indicator material and the colorant to migrate along the wick.

In another aspect of the present disclosure, which may be used in combination with any other aspect or combination of aspects listed herein, the microcapsules are configured to respond to the activation heat and the activation pressure provided by a direct thermal print head.

In another aspect of the present disclosure, which may be used in combination with any other aspect or combination of aspects listed herein, the activation heat is between 90° C. and 110° C.

In another aspect of the present disclosure, which may be used in combination with any other aspect or combination of aspects listed herein, the activation pressure is between 1.5 to 8 pounds per inch.

In another aspect of the present disclosure, which may be used in combination with any other aspect or combination of aspects listed herein, the activation heat is between 100° C. and 200° C. and the activation pressure is between 4 to 15 pounds per inch.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the environmental indicator material comprises a polymer having side-chain crystallinity.

In another aspect of the present disclosure, which may be used in combination with any other aspect or combination of aspects listed herein, the environmental indicator material comprises an alkane wax.

In another aspect of the present disclosure, which may be used in combination with any other aspect or combination of aspects listed herein, the microcapsules are a gel.

In another aspect of the present disclosure, which may be used in combination with any other aspect or combination of aspects listed herein, the microcapsules are a protein.

In another aspect of the present disclosure, which may be used in combination with any other aspect or combination of aspects listed herein, the microcapsules are polyurea formaldehyde.

In another aspect of the present disclosure, which may be used in combination with any other aspect or combination of aspects listed herein, the microcapsules are a wax material.

In another aspect of the present disclosure, which may be used in combination with any other aspect or combination of aspects listed herein, the microcapsules are emulsions.

In another aspect of the present disclosure, which may be used in combination with any other aspect or combination of aspects listed herein, the microcapsules have an outer diameter length between 20 to 250 μm.

In another aspect of the present disclosure, which may be used in combination with any other aspect or combination of aspects listed herein, the microcapsules respond by fracturing, melting, breaking, dissolving, or becoming porous.

In another aspect of the present disclosure, which may be used in combination with any other aspect or combination of aspects listed herein, the microcapsules have at least a first wall and a second wall encapsulating the environmental indicator material. The first wall is configured to respond to the predetermined environmental stimulus and the second wall is configured to respond to a second predetermined environmental stimulus.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the second predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, an activatable environmental sensor print medium comprising a substrate, an environmental indicator material configured to respond to a predetermined environmental stimulus, and a plurality of microcapsules on or embedded in the substrate containing the environmental indicator material. The microcapsules are configured to respond to at least one of an activation heat and an activation pressure by allowing the environmental indicator material to be released from the microcapsules. The environmental indicator material, after being released from the microcapsules, is configured to migrate along the substrate in response to exposure to the predetermined environmental stimulus by causing a detectable response.

In another aspect of the present disclosure, which may be used in combination with any other aspect or combination of aspects listed herein, the activatable environmental sensor print medium further comprises a wick on or in the substrate and is positioned to allow the released environmental indicator material to migrate along the wick.

In another aspect of the present disclosure, which may be used in combination with any other aspect or combination of aspects listed herein, the wick is made from a material selected from the group consisting of filter paper; pulverized filter paper; fine silica gel; porous films containing polytetrafluoroethylene resin or silica gel; TESLIN microporous synthetic sheet; non-woven, spun bonded materials including non-woven, spun-bonded high-density-polyethylene, polypropylene and polyester, and non-woven, spun-bonded blends of any two or more such polymers.

In another aspect of the present disclosure, which may be used in combination with any other aspect or combination of aspects listed herein, the detectable response is selected from a group consisting of a color state change, a change in transparency, a change in hue, a change in an electrical property, a change in conductivity, a change in capacitance, movement of the environmental indicator material along the substrate, and combinations thereof.

In another aspect of the present disclosure, which may be used in combination with any other aspect or combination of aspects listed herein, the environmental indicator material is configured to respond to exposure to the predetermined environmental stimulus by migrating along the substrate.

In another aspect of the present disclosure, which may be used in combination with any other aspect or combination of aspects listed herein, the environmental indicator material further comprises a meltable solid configured to melt in response to a predetermined temperature above a threshold, forming a liquid that migrates along the substrate for at least a predetermined distance when remaining at a temperature above the threshold for at least a predetermined time period.

In another aspect of the present disclosure, which may be used in combination with any other aspect or combination of aspects listed herein, the environmental indicator material further includes a colorant that migrates together with the liquid, and the detectable response is a change in color in a location to which the environmental indicator material has migrated.

In another aspect of the present disclosure, which may be used in combination with any other aspect or combination of aspects listed herein, the environmental indicator material comprises a gel configured to, in response to a predetermined temperature above a threshold, change viscosity causing the gel to migrate along the substrate for at least a predetermined distance when remaining at a temperature above the threshold for at least a predetermined time period.

In another aspect of the present disclosure, which may be used in combination with any other aspect or combination of aspects listed herein, the environmental indicator material further includes a colorant that migrates together with the gel.

In another aspect of the present disclosure, which may be used in combination with any other aspect or combination of aspects listed herein, the microcapsules are configured to respond to the activation heat and the activation pressure provided by a direct thermal print head.

In another aspect of the present disclosure, which may be used in combination with any other aspect or combination of aspects listed herein, the activation heat is between 90° C. and 110° C.

In another aspect of the present disclosure, which may be used in combination with any other aspect or combination of aspects listed herein, the activation pressure is 1.5 to 8 pounds per inch.

In another aspect of the present disclosure, which may be used in combination with any other aspect or combination of aspects listed herein, the activation heat is between 100° C. and 200° C. and the activation pressure is between 4 to 15 pounds per inch.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the environmental indicator material comprises a polymer having side-chain crystallinity.

In another aspect of the present disclosure, which may be used in combination with any other aspect or combination of aspects listed herein, the environmental indicator material comprises an alkane wax.

In another aspect of the present disclosure, which may be used in combination with any other aspect or combination of aspects listed herein, the microcapsules are a gel.

In another aspect of the present disclosure, which may be used in combination with any other aspect or combination of aspects listed herein, the microcapsules are a protein.

In another aspect of the present disclosure, which may be used in combination with any other aspect or combination of aspects listed herein, the microcapsules are polyurea formaldehyde.

In another aspect of the present disclosure, which may be used in combination with any other aspect or combination of aspects listed herein, the microcapsules are polymelamine formaldehyde.

In another aspect of the present disclosure, which may be used in combination with any other aspect or combination of aspects listed herein, the microcapsules are a wax material.

In another aspect of the present disclosure, which may be used in combination with any other aspect or combination of aspects listed herein, the microcapsules are emulsions.

In another aspect of the present disclosure, which may be used in combination with any other aspect or combination of aspects listed herein, the microcapsules have an outer diameter length between 20 to 250 μm.

In another aspect of the present disclosure, which may be used in combination with any other aspect or combination of aspects listed herein, the microcapsules respond by fracturing, melting, breaking, dissolving, or becoming porous.

In another aspect of the present disclosure, which may be used in combination with any other aspect or combination of aspects listed herein, the microcapsules have at least a first wall and a second wall encapsulating the environmental indicator material. The first wall is configured to respond to the predetermined environmental stimulus and the second wall is configured to respond to a second predetermined environmental stimulus.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the second predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, a method of activating an environmental sensor print medium comprises a first step of receiving a substrate that has a plurality of microcapsules on or embedded in the substrate and an environmental indicator material contained within the microcapsules. A second step includes applying at least one of an activation heat and an activation pressure by allowing the environmental indicator material to be released from the microcapsules. The microcapsules are configured to respond to at least one of an activation heat and an activation pressure by allowing the environmental indicator material to be released from the microcapsules. The environmental indicator material, after being released from the microcapsules, is configured to respond to exposure to a predetermined environmental stimulus by causing a detectable response.

In another aspect of the present disclosure, which may be used in combination with any other aspect or combination of aspects listed herein, the substrate is a label print stock.

In another aspect of the present disclosure, which may be used in combination with any other aspect or combination of aspects listed herein, the information is printed using a direct thermal printer and the activation heat and pressure is applied using the same thermal printer that is used to print information on the label print stock.

In another aspect of the present disclosure, which may be used in combination with any other aspect or combination of aspects listed herein, the method further comprises a step of applying the printed label to a host product or applying the label print stock to a host product prior to printing the information.

In another aspect of the present disclosure, which may be used in combination with any other aspect or combination of aspects listed herein, the microcapsules have at least a first wall and a second wall encapsulating the environmental indicator material. The first wall is configured to respond to the predetermined environmental stimulus and the second wall is configured to respond to a second predetermined environmental stimulus.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

In another aspect of the present disclosure, which may be used in combination with any other aspect or combination of aspects listed herein, the second predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of the layers of an activatable environmental sensor print medium, according to an example of the present disclosure.

FIG. 2 illustrates a cross-sectional view of a microcapsule containing an environmental indicator material, according to an example of the present disclosure.

FIG. 3 illustrates a micrograph view of microcapsules containing an environmental indicator material, according to an example of the present disclosure.

FIG. 4 illustrates a micrograph view of microcapsules containing an environmental indicator material after the occurrence of an activation event, according to an example of the present disclosure.

FIG. 5 illustrates a micrograph view of microcapsules containing an environmental indicator material after the occurrence of an activation event, according to an example of the present disclosure.

FIG. 6 illustrates a cross-sectional view of a microcapsule having two microcapsule shells and containing an environmental indicator material, according to an example of the present disclosure.

FIG. 7 illustrates an activatable environmental sensor print medium in a non-activated configuration, according to an example of the present disclosure.

FIG. 8A illustrates an activatable environmental sensor print medium in an activated configuration after the microcapsules have ruptured, but prior to the environmental sensor being exposed to the corresponding predetermined environmental stimulus, according to an example of the present disclosure.

FIG. 8B illustrates an activatable environmental sensor print medium in an activated configuration after the microcapsules have ruptured, but prior to the environmental sensor being exposed to the corresponding predetermined environmental stimulus with an activation indicator material displaying the activation, according to an example of the present disclosure.

FIG. 9 illustrates an activatable environmental sensor print medium in an activated configuration after full exposure to the predetermined environmental stimulus, according to an example of the present disclosure.

FIG. 10 illustrates an activatable environmental sensor print medium in a non-activated configuration with a top viewing layer having a viewing window, according to an example of the present disclosure.

FIG. 11A illustrates an activatable environmental sensor print medium in an activated configuration after the microcapsules have ruptured, but prior to the environmental sensor being exposed to the corresponding predetermined environmental stimulus with an activation indicator material displaying the activation, according to an example of the present disclosure.

FIG. 11B illustrates an activatable environmental sensor print medium in an activated configuration with the environmental indicator material having been exposed to the predetermined environmental stimulus, according to an example of the present disclosure.

FIG. 12 illustrates an activatable environmental sensor print medium in various stages before and after exposure to an activation event.

FIG. 13A illustrates a first method of activating an activatable environmental sensor print medium, according to an example of the present disclosure.

FIG. 13B illustrates a second method of activating an activatable environmental sensor print medium, according to an example of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure describes environmental indicator materials contained within activatable microcapsules that may be activated by heat and/or pressure, e.g., using a thermal print head of a conventional or modified thermal printer. These indicators may be provided in modified versions of thermal print media stock, so that, in some cases, the same thermal printer may be used both to print on the media and to activate, or selectively activate the environmental indicators. The activatable environmental indicators may be used for other types of activatable environmental exposure indicators, and particularly exposure indicators, such as radiation, oxygen, light, ultraviolet (UV), humidity, or simply the passage of time, as described in greater detail below.

Additionally, techniques for printing activatable environmental exposure indicators, such as temperature excursion or time-temperature exposure indicators, using a thermal printer stock are disclosed. Prior applications involving thermal printing have not addressed using an activatable environmental indicator material contained in microcapsules. While such prior indicators may be configured to be thermally printed, the indicators are provided on the thermal print stock, but are not activated by the thermal printer—they instead are active approximately from the instant the indicator materials are provided on the print stock. Either the thermal printer is configured to avoid printing on the indicator material, or the indicator material is insulated or otherwise configured so it is not materially affected by the thermal printing process, or in some cases for example in Zebra Technologies U.S. patent application Ser. No. 17/877,287, the thermal printer is intentionally used to print some of the environmental indicator materials, so they are placed into the state showing they have been exposed to a temperature excursion. Also, in those prior approaches, existing thermal printing processes often print static information that is not intended to be sensitive to environmental factors such as temperature, time, time-temperature product, freezing, nuclear radiation, toxic chemicals, or the like.

These activatable environmental indicators have been generally limited as environmental sensing of materials below ambient temperature requires materials that are manufactured and handled (e.g., shipped and stored) in environments below the response temperature. By facilitating activation of the indicators at the end point of application, storage, shipping and manufacturing costs for the indicators may decrease and the reliance on activation methods can increase.

A need exists for an activatable medium that is easily employed by an end-user and provides efficient, on-demand activation during the printing of labels containing environmental exposure indicators of various types.

The present disclosure describes environmental exposure indicator (including indicators that simply show the passage of time) which may be provided as part of a printable medium, such as printable webs, paper, or other print stocks. The indicators may be provided initially in an inactive state, so they tend not respond to the environmental stimulus of interest. This may be accomplished, e.g., by having an indicator which indicates exposure to the environmental stimulus by the reaction of two or more components that are physically separated prior to activation by a barrier. In this manner, the environmentally sensitive indicators may be provided as part of a special print stock that may be printed and activated during the printing process. Another approach to this is to encapsulate the environmental indicator materials (e.g., in microcapsules) to prevent the environmental indicator materials and/or environmental sensors including the environmental indicator materials from reacting to the environment when the response condition is satisfied and to selectively activate the indicator materials and/or the environmental sensor including the environmental indicator material by rupturing the encapsulation to release the indicator materials as described herein and in concurrently filed related applications: U.S. Patent Application, titled “MEDIA PROCESSING DEVICE AND COMPONENTS FOR ACTIVATABLE MEDIA PLATFORMS”, Attorney Docket No. 0820887.00358; U.S. Patent Application, titled “MEDIA CONSTRUCTION TO FACILITATE USE OF ACTIVATABLE PLATFORM”, Attorney Docket No. 0820887.00359; U.S. Patent Application, titled “USE OF ENCAPSULATED POLAR PROTIC CHEMISTRIES FOR RFID TEMPERATURE MONITORING”, Attorney Docket No. 0820887.00355; and U.S. Patent Application, titled “RIBBON FOR USE IN PRODUCING PRINTER ACTIVATABLE INDICATORS”, Attorney Docket No. 0820887.00356.

As used herein, the term “activation event” is a treatment, e.g., the exposure to certain amount of heat and/or pressure that causes the activation material to cease preventing the environmental exposure indicator from operating. The activation event may include the application of an activation heat, an activation pressure, or a combination thereof. The use of applied heat may reduce the amount of pressure required for activation as compared to activation without applied heat, or vice versa.

As used herein, the term “non-activated configuration” refers to a configuration in which the microcapsules fully encapsulate the environmental indicator material inhibiting the operation of the environmental indicator material so that the environmental indicator material will not respond, or will respond only in a materially reduced manner, to the relevant predetermined environmental stimulus. The “activated configuration” refers to a configuration in which the environmental indicator material is not fully contained within the microcapsules such that the environmental indicator material will respond in its intended fashion to the relevant predetermined environmental stimulus, e.g., depending on the type of environmental indicator, either immediately upon exposure beyond a threshold, or over time, or over a rate dependent on amount of exposure.

As used herein, the term “activation device” is a device configured to selectively cause the microcapsules to transition from its non-activated configuration to its activated configuration.

As used herein, the term “print head” refers to a component of an activation device that transfers heat and/or pressure to an activatable print medium in response to an instruction from the activation device.

As used herein, the term “predetermined environmental stimulus” is an environmental condition in which the environmental indicator material is configured to respond. The predetermined environmental stimulus may include, but is not limited to, temperature excursion above a predetermined temperature threshold, temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

As used herein, the term “environmental indicator material” refers to a material that exhibits a detectable response after being released from the microcapsules when it is exposed to a predetermined environmental stimulus. The detectable response may include a color state change, a change in transparency, a change in hue, a change in an electrical property, a change in conductivity, a change in capacitance, movement of the environmental indicator material along a substrate, or combinations thereof. In some embodiments, the environmental indicator material is configured to undergo a continuous chemical or physical state change between an “initial state” and an “end state”. In some embodiments, the change of state may be a change in a property, e.g., an optical property, such as a reflectance value, saturation value, color value, color density value, optical density value or color hue value of the “reactive component” or an electrical property. Specifically, the state change (e.g., optical property change) may provide exposure information indicating an exposure to an environmental stimulus since the environmental exposure indicator was in the “activated configuration.”

### Activation Using Thermal Printer or Other Device

A conventional thermal printing technology for printing dataforms or images, such as barcode symbols and/or text, is direct thermal printing. A direct thermal printer does not use a ribbon, but instead the printable media itself is the thermal media. The direct thermal media is manufactured or coated with a thermochromic material that changes color when exposed to sufficient heat, such as a leuco dye, which switches from a first chemical form that is colorless to a second chemical form that is black or colored. The web of direct thermal media is pressed against and moved past the thermal print head. The thermal print head receives data of a rendered bitmap and heats specific heating elements within the row of addressable heaters according to the data.

To print labels or other documents, thermal printers may use a thermal print head comprising a row of addressable heating elements to heat a thermal media. The elements are small compared to the image to be printed; e.g., 8, 12, or 24 elements per mm are typical, and other resolutions, are commercially available. This differs from thermal inkjet printers which use addressable heaters to heat an ink or wax that is dropped or ejected to a document or other printable media.

Heat from the heated elements causes the thermochromic material on the printable media to transition from colorless to black or from colorless to colored. Print head heating elements which are not heated do not cause a color transition. In some direct thermal media, a first zone of the printable media includes thermochromic material that transitions from colorless to a first color while a second zone of the printable media includes thermochromic material that transitions from colorless to a second different color. Some direct thermal media comprises a multi-layer arrangement including a first layer of a first color and a second non-transparent layer of a second color. For the multi-layer arrangements, heat from the heated print head elements cause the second layer to transition to a transparent state revealing the color of the first layer.

Conventional print media may be used as a carrier to hold the environmental indicator materials which then may be activated using an activation device, e.g., a thermal printer. The conventional print media backing may be placed either underneath the transparent upper layers or on the bottom most portion of the environmental indicator beneath the activatable portion, or applied as an additional layer over top of the print media, or incorporated as an element of an existing layer by modifying the process for manufacturing the conventional print media. Additionally, certain layers of the environmental indicators may also include conventional printer media elements as a supportive substrate.

In addition to the media being printable with a conventional thermal printing process, the activatable environmental sensor print medium is activatable as a result of exposure to temperature or pressure changes, e.g., from heat and pressure applied using the conventional thermal print head. The microcapsules on or embedded in the print media or other substrate may be configured such that the activatable environmental sensor print media is sensitive to high temperature the application of pressure. As result of exposure to a sufficiently high temperature or pressure, the configuration of the layers of the activatable environmental sensor print media may be altered. While layers are shown, it will be appreciated that approaches may be employed, e.g., using walls that prevent lateral movement of reactants that are broken by activation. The materials and thermal print head may be tuned, so that the activation takes place at the same, lower, or higher temperature than the conventional thermal printing process. As a result of the configuration of the layers of the activatable environmental sensor print media being altered, the activatable environmental sensor print media is activated, and may then operate as an environmental exposure indicator, which is configured to provide an indication of the historical exposure of the activatable environmental sensor print media to the predetermined environmental stimulus that occurs after activation. In indicators where thermal print regions and activatable indicator overlap, it may be advantageous to have materials with significantly different response characteristics, so that the conventional printing and activatable media can each be triggered without activating the other, e.g., one may require a higher temperature to be triggered, while the other responds to a lower temperature but requires a longer exposure time. Alternatively, the materials may be place in different areas of the printable medium.

### Activatable Environmental Sensor Print Medium

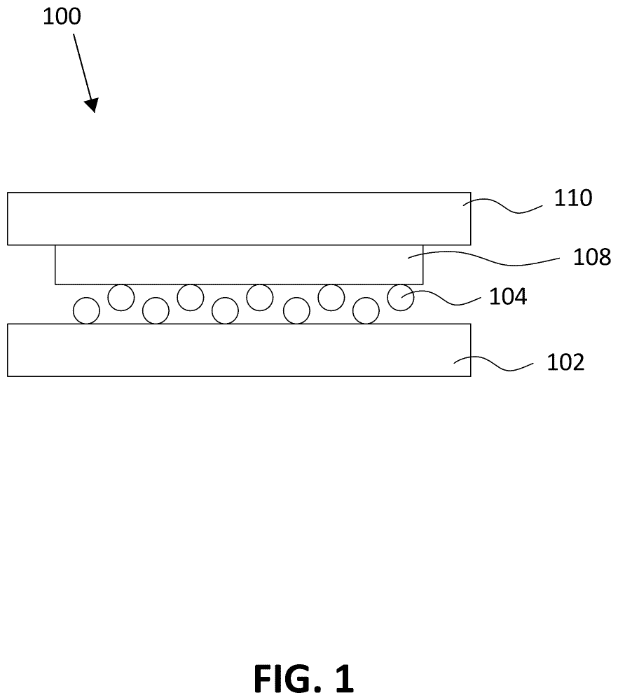

FIG. 1 illustrates a perspective view of the layers of an example activatable environmental sensor print medium 100. Optionally, the medium may contain conventional elements of a thermal print media, e.g., it may be constructed by adding environmental indicator components to a conventional thermal print media components, so that the print medium can still be printed using a conventional thermal printing process. Optionally, the medium may have a predetermined pattern, with conventional thermal print media structure in some predetermined locations, and with environmental indicator materials and activatable microcapsules in other locations. Alternatively, the conventional print media elements and environmental indicators may, in some cases overlap.

The activatable environmental sensor print medium 100 may include a base substrate 102, microcapsules 104 containing an environmental indicator material 106, a clear overlaminate film 108, and, in some embodiments, a top viewing layer 110.

The substrate 102 may be a printable substrate, e.g., a web material, e.g., paper such as a cellulose paper, polymer film substrate, a metallic layer, such as a metallic aluminum layer or an absorbent substrate. In some examples, the substrate 102 may have a thickness in a range of about 10 mm to about 20 mm, from about 1 mm to about 10 mm or from about 10 mm to about 20 mm. The substrate 102 may be one of a Polyolefin, polyamide, polypropylene, polyester Polyimide, Polyart synthetic paper, nylon, or PPG Teslin paper. In an example, there may be a topcoat applied to the substrate 102. Optionally, the substrate 102 may further include a release liner and/or an adhesive backing to allow the activatable environmental sensor print medium 100 to be selectively attached to surfaces, e.g., as a label. Depending the application, the activatable environmental sensor print medium 100 may be provided as a continuous web of material that may be cut, or that may be perforated for easy separation into individual indicators, or as precut label print stock in a desired form factor. In some methods as described further below, information may be printed onto the label print stock to product a printed label. The information is printed using a direct thermal printer which may also apply the activation event required to activate the microcapsules 104.

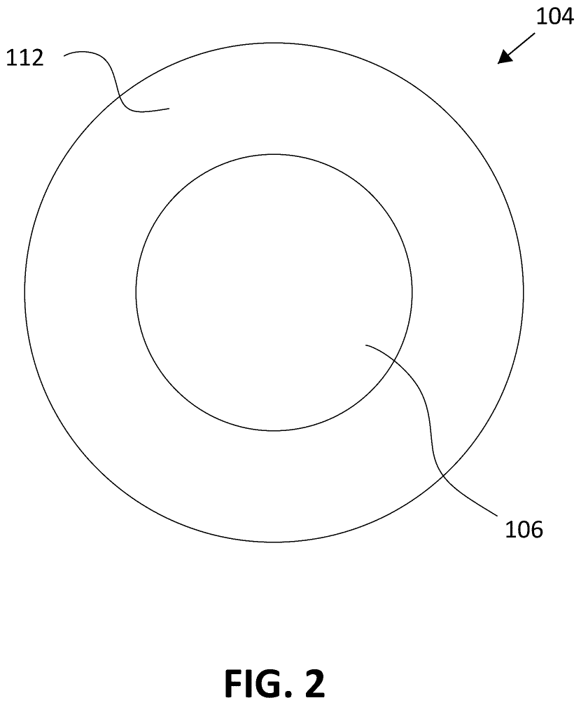

Atop or embedded within the substrate 102 are the microcapsules 104 containing the environmental indicator material 106 (shown in FIG. 2). The microcapsules 104 can be selective disposed on the substrate 102 in designated area(s) and/or can be disposed on the substrate 102 to generally coat the substrate 102. There are a plurality of methods to deposit the microcapsules 104 onto the substrate 102. One method is a drawdown coating method. The method includes applying the microcapsules 104 along a width of the substrate 102 and then spreading the microcapsules 104 along the substrate 012 with a drawdown rod. The drawdown rod spreads the microcapsules 104 along the substrate 102 to a thickness to form a transfer layer of the microcapsules 104. The microcapsules 104 can then dry to the substrate 102. In at least one aspect, the microcapsules 104 are added to a wax layer and applied to the substrate 102 using the drawdown coating method. In certain embodiments, other methods of manufacture may be used. Flexographic printing cylinders and rollers may be used to coat material onto the substrate 102, then the substrate 102 may be cut and/or wound for loading into a printer. Retransfer methods may also be used, such as ink jetting material onto the substrate 102 or depositing the microcapsules 104 on the substrate 102 using a thermal transfer apparatus.

The activatable environmental sensor print medium 100 may include a clear overlaminate film 108 isolating and/or protecting the microcapsules 104. The clear overlaminate film 108 is an overlay component that overlays the microcapsules 104 and substrate 102. The overlaminate film 108 may be one of Fasson Faslam clear polypropylene, Avery Dennison® DOL series vinyl (PVC), any conformable overlaminate films, Apco PET or BOPP overlaminate films. The clear overlaminate film 108 allows a user to view through the clear overlaminate film 108 to see the layers below including the substrate 102 and microcapsules 104 while isolating and/or protecting the layers such that the layers (e.g., the substrate 102 and microcapsules 104 can be seen, but not touched. Depending on the desired application, the clear overlaminate film 108 may optionally be ultraviolet (UV) blocking, water resistant, hermetically sealed, chemically resistant, or merely a barrier to physical abrasion to protect the layers below the overlaminate film 108.

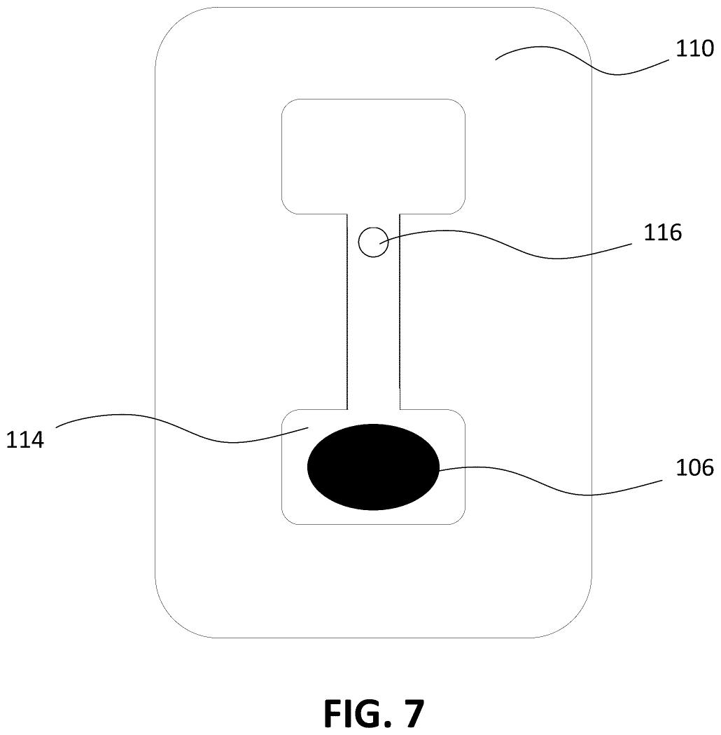

Finally, in some embodiments, the top viewing layer 110 may be placed atop the clear overlaminate film 108. The top viewing layer 110 may be any material suitable for displaying the microcapsules 104 and environmental indicator material 106, e.g., porous materials for bar codes printed using inks, etchable materials for laser-etched bar codes, paper, nylon, vinyl, other synthetic polymers such as polytetrafluoroethylene (“PTFE”), or other materials that are suitable for receiving and displaying the microcapsules 104 and environmental indicator material 106. The top viewing layer 110 may, for example, be paper or film (e.g., nylon, vinyl, synthetic polymer material, carbon fiber, Teslin synthetic paper, polyethylene (“PE”), polypropylene (“PP”), polytetrafluoroethylene (“PTFE”), polyester, polyethylene, polyolefin, polyimide, vinyl, acrylic film, polypropylene, non-woven nylon, coated and non-coated direct thermal paper, printable polyethylene terephthalate (“PET”), oriented polypropylene (“OPP”), biaxially oriented polypropylene (“BOPP”). In some embodiments, the top viewing layer 110 may be printed on with ink jetting material onto the substrate 102 or can be coated with a thermochromic material. Additionally, the top viewing layer may include holes or viewing windows 116 (e.g., as shown in FIG. 7) as described further below.

### Microcapsules

FIG. 2 illustrates a cross-sectional view of a microcapsule 104 wherein the microcapsule 104 contains a shell 112 encapsulating the internal environmental indicator material 106. The microcapsule 104 may be any size, but in one such embodiment, has an outer diameter length between 50 to 250 μm. The shell 112 may be any size smaller than or equal to the outer diameter of the microcapsule 104, but in one such embodiment, has an outer diameter length between 5 to 25 μm. The payload, or the ratio of the total weight of the environmental indicator material 106 within the microcapsule 104 to the entire weight microcapsule 104 including the environmental indicator material 106 contained within the microcapsule 104, can range from 50% to 90%. It will be appreciated that a variety of microcapsule shell 112 materials may be chosen, depending on the application, the type of activation, and the nature of the environmental indicator material 106. In general the microcapsules 104 should resist the passage, whether by flow, diffusion, or migration, of the environmental indicator material 106 prior to activation. For example, the microcapsules 104 may be a wax, e.g., an alkane wax, or other acid resistant compound having a relatively high melting point, e.g., fatty acid amide, an ester or Elvax EVA resin. For example, the melting point may be in a range of about 50° C. to about 300° C., from about 100° C. to about 300° C., from about 150° C. to about 300° C., from about 200° C. to about 300° C., from about 250° C. to about 300° C.

In another example, the microcapsules 104 may be polymer coating having a high glass transition temperature (Tg) e.g. Polysulfone. For example, the glass transition temperature may be in a range of about 50° C. to about 300° C., from about 100° C. to about 300° C., from about 150° C. to about 300° C., from about 200° C. to about 300° C., from about 250° C. to about 300° C. For example, polysulfone, with a Tg of about 190 C may be used. In additional examples, the microcapsules 104 may be one of Styrene Maleic Anhydride (SMA), Polyphenylene Ether (PPE), Cellulose Acetate, Cellulose Diacetate, Polyarylate, Polyamide, Polycarbonate, polyether ether ketone, Polyether Sulfone, PET, PFA, polymethyl methacrylate (PMMA) or Polyimide. In another example, the microcapsules 104 are a low molecular weight polymer gel having a high melting point, e.g., fatty acid amide, an ester or Elvax EVA resin. For example, the melting point may be in a range of about 100° C. to about 300° C., from about 150° C. to about 300° C., from about 200° C. to about 300° C., from about 250° C. to about 300° C. Additionally, in some examples, the polymer gel has a molecular weight in a range from about 1 g/mol to 100,000 g/mol, from about 3,500 g/mol to 6,000 g/mol and from about 200 g/mol to 2,000 g/mol. Alternatively, the microcapsules 104 may be a gel, gelatin, protein, polyurea formaldehyde, polymelamine formaldehyde, wax material, melamine, or an emulsion. The microcapsules may be available in wet and dry formulations. Polymelamine and polyurea formaldehyde can both be used for encapsulations via interfacial polymerization, which uses two immiscible phases. Once separated in the same vessel, a reaction is initiated at the interface of the two immiscible phases in the presence of an initiator and the material to be encapsulated. As polymerization occurs, microcapsules form around the core material. The microcapsule 104 releases the environmental indicator material 106 upon rupturing the microcapsule 104.

FIG. 2 illustrates the microcapsule 104 initially in an unactivated form, capable of being configured to transition to an activated form when activated through exposure to an activating event, e.g., the heat, pressure, and/or heat and pressure of a thermal print head. In the unactivated form, the microcapsule 104 maintains separation between the environmental indicator material 106 and any external environmental stimuli and/or contains a response of the environmental indicator material 106 in response to any external environmental stimuli.

The activatable environmental sensor print medium 100 may be activated through exposure of the microcapsules 104 to an activation event. The activation event may cause the fracturing, melting, breaking, dissolving, subliming, or becoming porous, allowing the release of its contents. For example, the activation event may be an application of at least one of an activation heat and an activation pressure. In some examples, the microcapsule 104 may be selectively activated, e.g., by activating only a portion of the microcapsules, the microcapsules in particular locations. In some examples, the temperature threshold for activation may be from about 0° C. to 300° C., from about 90° C. to 110° C., from about 100° C. to 200° C., from about 100° C. to 300° C., and from about 200° C. to 300° C. Activation may be achieved by applying a high temperature for a very short interval, e.g., a few milliseconds. In this manner, even if the temperature needed to activate the device exceeds the temperature that a temperature exposure indicator is configured to indicate, the exposure may be so short that the indicator itself is not affected. For example, the mass or heat of fusion of the indicator may be much greater than the mass or heat of fusion of a barrier that needs to be removed, allowing a short exposure to high temperature to remove or alter the microcapsule 104 without significantly affecting the environmental indicator material 106 itself. Typical thermal print heads have temperatures in the range from about 100° C. to 300° C., which may be tuned downward for select applications to from about 100° C. to 200° C. They are typically exposed to the thermal print heads for a brief period of time, for example a few milliseconds. The microcapsules 104 itself responds when it reaches a temperature of in a range from about 0° C. to 150° C., from about 0° C. to 50° C., from about 50° C. to 100° C., from about 90° C. to 110° C., from about 100° C. to 150° C., from about 100° C. to 200° C. It will be appreciated that the activation heat ranges given are purely exemplary and the microcapsules 104 can be formed to response to other temperature ranges. In some cases, pressure may also contribute to the activation, e.g., by breaking microcapsules 104, either alone like an impact printer, or in combination with elevated temperature. In some examples, the activation pressure required to activate the microcapsules 104 may be from about 1.5 to 8 pounds per square inch or from about 4 to 15 pounds per square inch. In some instances, the microcapsules 104 may be exposed to heat and pressure from a Zebra ZT100 direct thermal printer or other thermal printer, applying a pressure of approximately 8 pounds per square inch and a temperature of 300° C. As an example, the ZT100 direct thermal printer can apply between 4 to 20 pounds per square inch and heat a material up to about 320° C. It will be appreciated that the activation pressure ranges given are purely exemplary and the microcapsules 104 can be formed to respond to other pressure ranges.

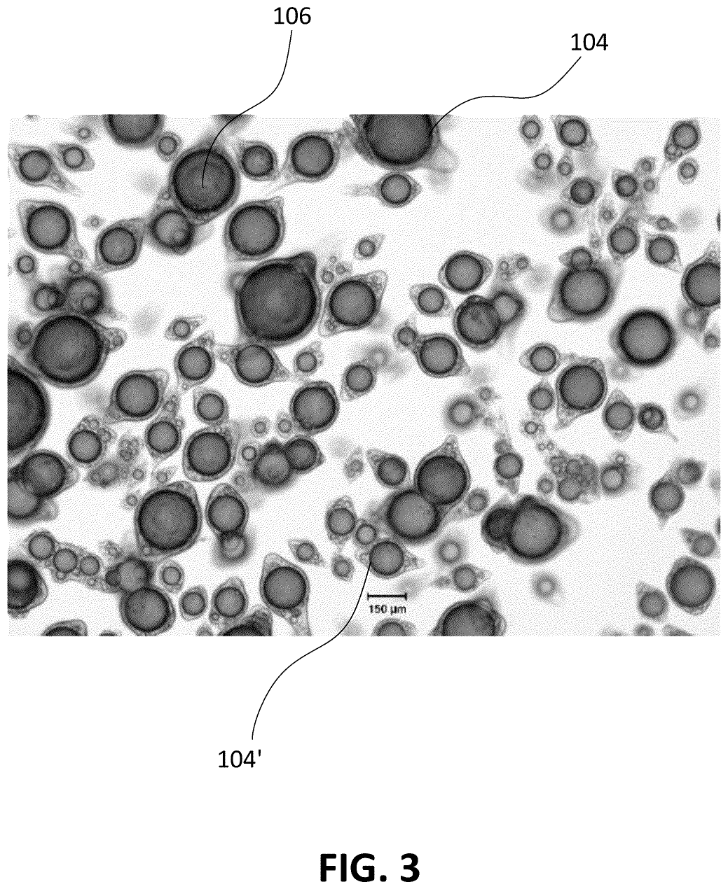

FIG. 3 illustrates a micrograph including one example of microcapsules 104 according to the present disclosure. In this example, the microcapsules 104 contain an environmental indicator material 106 such as those described below. The shell 112 of the microcapsule 104 may be any material as described above. The microcapsules 104 vary in size, but one such microcapsule 104′ is approximately 150 μm. There are microcapsules 104 that are both bigger and smaller than 150 μm.

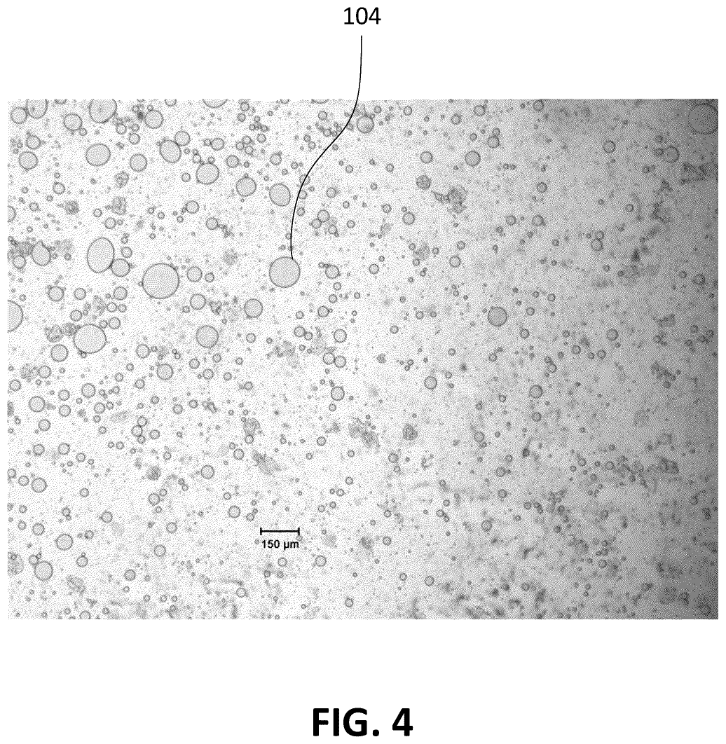

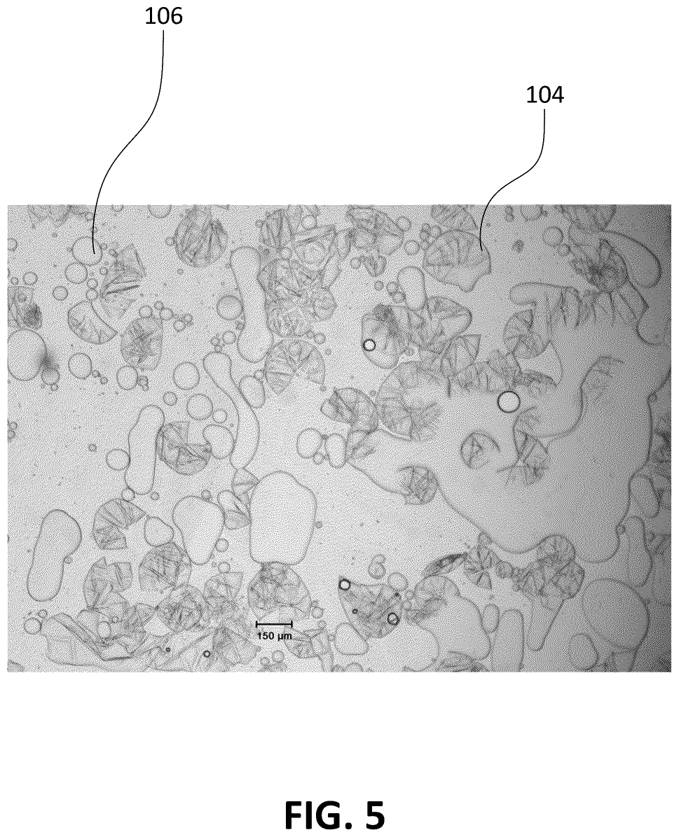

FIG. 4 illustrates another micrograph including another example of microcapsules 104 according to the present disclosure. In this example, the microcapsules 104 contain an environmental indicator material 106 such as those described below. The shell 112 of the microcapsule 104 may be any material as described above. The microcapsules 104 vary in size, but no microcapsule 104 exceeds approximately 150 μm. FIG. 5 illustrates a micrograph of the microcapsules 104 of FIG. 4 after exposure to an activation event.

In some examples, exposure to an activation event, the application of at least one of a heat and pressure, causes the microcapsules 104 to undergo a phase change and at least one of (i) flow away, (ii) sublimate, or (iii) become porous. In some examples, this may even result in complete or near-complete removal of the microcapsules 104. In other cases, portions of the microcapsules 104 may remain, e.g., as a porous layer that allows diffusion of the environmental indicator material 106.

The activation event may be carried out using an activation device. In some examples, the activation device may be a device that includes a processor, a memory coupled to the processor and a thermal print head, e.g., a conventional thermal printer with software modifications.

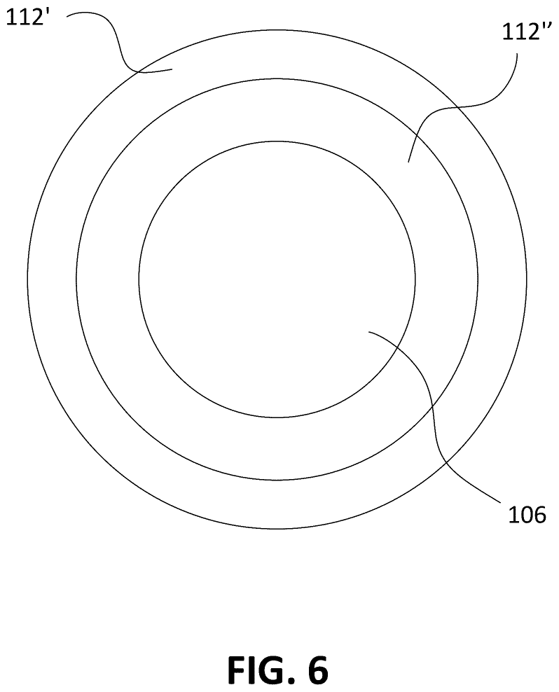

In some embodiments, there may be two or more shells 112 within a microcapsule 104 providing a barrier to the environmental exposure indicator 106. FIG. 6 shows an embodiment with two separate shells, 112′, 112″, encapsulating the environmental exposure indicator 106. Each shell 112′, 112″ may be configured to respond to a different activation event thus ensuring that the environmental indicator material 106 is only released after or in response to exposure to specific activation events. As one example, the first shell 112′ may be configured to respond to a certain activation pressure otherwise insulating the second shell 112″ from exposure to a certain activation heat to which the second shell 112″ responds. As one example, the first shell 112′ may be configured to respond to a first activation pressure and/or temperature and the second shell 112″ may be configured to respond to a second pressure and/or temperature that is higher than the first pressure and/or temperature. In this regard, the utilization of multiple shells can tailor the order of conditions to which the environmental sensor print medium 100 be exposed in order to activate.

There are many approaches to create the microcapsules 104 encapsulating the environmental indicator material 106. One such approach involves emulsifying materials such as a gel, gelatin, protein, polyurea formaldehyde, polymelamine formaldehyde, wax material, melamine, or an emulsion into an outer shell material. The environmental indicator is placed in the center of a disk. The outer shell material is then pumped into the center of a disk. The core material, such as an environmental indicator material 106, is surrounded by the outer shell 112 formed by the outer shell material as it enters the disk. The disk may have a plurality of nozzles on an exterior surface of the disk. The nozzles are connected to the center of the disk. The disk acts as a centrifuge and is rotated in a direction to produce microcapsules 104 with a narrow particle size distribution. Because of the centrifugal force exerted on the microcapsules, particles of certain sizes are thus separated. The microcapsule 104 size can be controlled by altering the rotation speed of the disk to produce larger or smaller particles. The microcapsules 104 have an outer shell material that surrounds a core material.

Alternative approaches to production of the microcapsules may include EHD coextrusion, stationary coextrusion, submerged nozzle coextrusion, pan coating, vibrating nozzle, centrifugal coextrusion, fluid bed coating, spray drying, rotating disk, in situ polymerization, solvent evaporation, interfacial polymerization, phase separation, simple coacervation, complex coacervation, sol-gel methods, liposomes, and nanoencapsulation.

### Environmental Indicator Material

The present disclosure includes an environmental indicator material 106 encapsulated in the activatable microcapsules 104, e.g., as shown in FIGS. 2-4 and 6. The microcapsules 104 may be utilized in order to prevent wicking, or migration, of the environmental indicator material 106 prior to an activation event even when the environmental indicator material 106 encapsulated in the microcapsules is exposed to a predetermined environmental stimulus (e.g., temperature or light). Alternatively, the microcapsule 104 may insulate the environmental indicator from a predetermined environmental stimulus (e.g. exposure to a particular gas, humidity, or light).

The environmental indicator material 106 may be any such material capable of exhibiting a detectable response upon the occurrence of a predetermined environmental stimulus, e.g., a material that when released interacts with another material to cause a change in color state, a material that liquefies and moves from its current location to another, a material that interacts with an electrical component to change an electrical property, etc. In some embodiments, the environmental indicator material 106 may be a thermochromic material, an alkane wax, dyed waxes, hydrochromic inks, specialized chemistry, polymer chemistry, polymers having side-chain crystallinity, and/or other phase change materials.

Most importantly, the environmental indicator material 106 is able to be tailored to change from at least a first material state to a second material state in response to a predetermined environmental stimulus. The material state may be a state of matter, e.g., changing from solid to liquid, a change in viscosity, how a material flows, color state, a transparency level, a hue, an electrical property, a conductivity, a capacitance, a distance the environmental indicator material 106 has traveled along the substrate, and combinations thereof. It will be appreciated that the above-mentioned material states are purely exemplary and other material state changes may exist. The response is detectable which may for example mean that it may be optically readable by a scanning device or readable by a human. It also may provide other detectable responses, e.g., a change in electrical property. The readability and human visibility of the environmental indicator material 106, in some examples, may only be detectable in one of the environmental indicator material's material states; for example the material may be transparent and effectively invisible in one state and have a readily visible opaque color in another state.

In some embodiments, there may be combinations of different environmental indicator materials 106 contained within microcapsules 104. This may include multiple types of microcapsules 104 containing multiple types of environmental indicator materials 106. The different environmental indicator materials 106 may be placed into microcapsules 104 to keep the environmental indicator materials 106 from pre-mature contact with each other, with a layer of an activatable environmental sensor print medium (e.g., the activatable environmental sensor print medium 100), with a wick (e.g., wick 114).

In one embodiment, the environmental indicator material 106 can also include an activation marker material, which upon release from the microcapsules 104 in response to an activation event can provide an indication that the microcapsules have been place in the activated configuration. Such an indication may or may not be visible to the human eye and/or may or may not be distinguished from the indicator material that provides a detectable response to a predetermined environmental stimulus. As an example, the activation marker material can include a dye having a predetermined color, a luminescent material, and/or a photochromic material. In some embodiments, microcapsules can be deposited in an activation indicator area of the printable medium, where these microcapsules include the activation marker material, and microcapsules including the environmental indicator material can be deposited in an environmental indicator area. In some embodiments, the activation indicator area and the environmental indicator area can be positioned in proximity and/or adjacent to each other. By positioning the activation indicator area in proximity and/or adjacent to the environmental indicator area, the activation indicator area and the environmental indicator area can experience an activation event in a similar manner, e.g., both areas can experience the same or nearly the same activation temperature and/or activation pressure. For example, if an environmental indicator material is black when exposed to the relevant environmental stimulus, but transparent initially, a person will not be able to tell, at a glance that the device has been activated. By adding a yellow dye to at least some microcapsules, the area will turn yellow when activated, thereby making it clear to a user that the device has been activated, but without confusing the user that the relevant environmental exposure has occurred.

In one embodiment, the environmental indicator material 106 is a meltable solid configured to melt in response to a predetermined temperature above a threshold, forming a liquid that migrates along the substrate 102 for at least a predetermined distance when remaining at a temperature above the threshold for at least a predetermined time period. In some embodiments, the environmental indicator material 106 may include a colorant that migrates with the liquid environmental indicator material 106.

In another embodiment, the environmental indicator material 106 is a gel configured to, in response to a predetermined temperature above a threshold, change viscosity causing the gel to migrate along the substrate 102 for at least a predetermined distance when remaining at a temperature above the threshold for at least a predetermined time period. In some embodiments, the environmental indicator material 106 may include a colorant that migrates with the gel environmental indicator material 106. For example, the material may be a side-chain crystallizable polymer combined with an alkane wax and colored dye as described in of U.S. Patent Publication 20220178761 applied for by Temptime Corporation, a Zebra Technologies company. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes. Suitable side-chain crystallizable (SCC) polymers useful in the practice of the present disclosure are also described in U.S. Pat. No. 5,156,911 at column 5, lines 67 to column 7, line 13, which disclosure is incorporated by reference herein for all purposes. Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc. Other materials may be SCC's alone without SCCs, or alkane waxes blended without SCCs.

### Example Time Temperature Exposure Indicator

The activatable indicator of the present disclosure may be combined with the time temperature indicator of U.S. Patent Publication 20220178761 applied for by Temptime Corporation, a Zebra Technologies company.

In some embodiments such as those shown in FIGS. 7-12, the environmental indicator material 106 may be configured to migrate along a wick 114. The wick 114 may be on or in the substrate 102 and positioned near the microcapsules 104 such that upon activation the environmental indicator material 106 may migrate along the wick 114. Thus, the wick 114 can be used as a tool of measurement to determine the extent or duration of the exposure the environmental indicator material 106 has had to the predetermined environmental stimulus. With a suitable material the migration of the environmental indicator material 106 along the wick may indicate the historical exposure to the predetermined environmental stimulus for a particular time period; the longer the exposure the more the material may travel down the wick.

The wick may be any material capable of allowing the environmental indicator material to migrate upon, including filter paper; pulverized filter paper; fine silica gel; porous films containing polytetrafluoroethylene resin or silica gel; TESLIN microporous synthetic sheet; non-woven, spun bonded materials including non-woven, spun-bonded high-density-polyethylene, polypropylene and polyester, or non-woven, spun bonded blends of any two or more such polymers. It will be appreciated that the use of a wick is purely exemplary and transport elements may be known to an artisan practicing ordinary skill in the art.

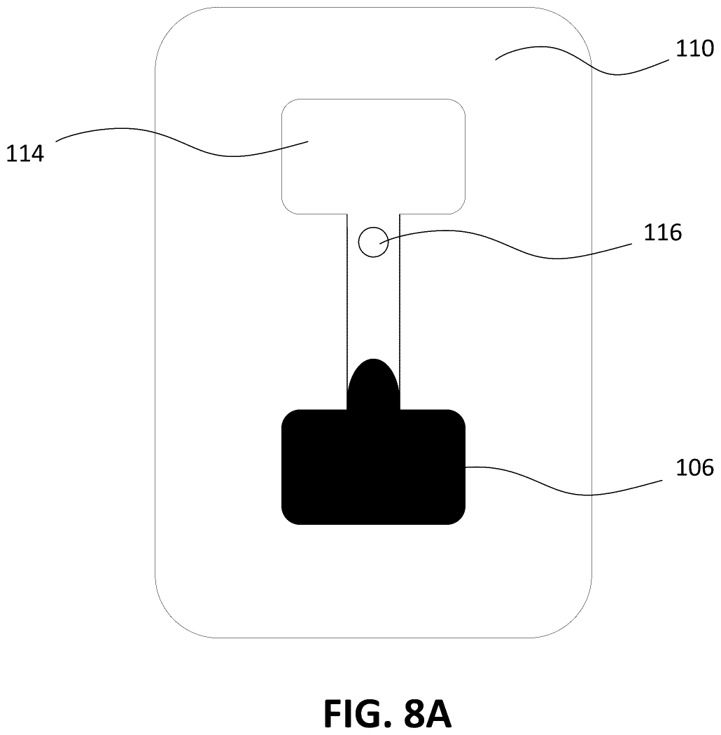

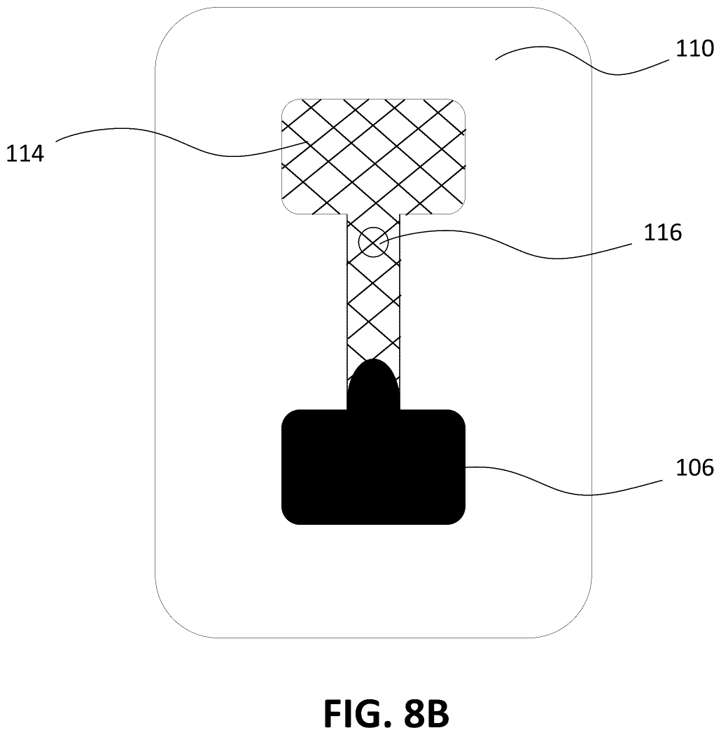

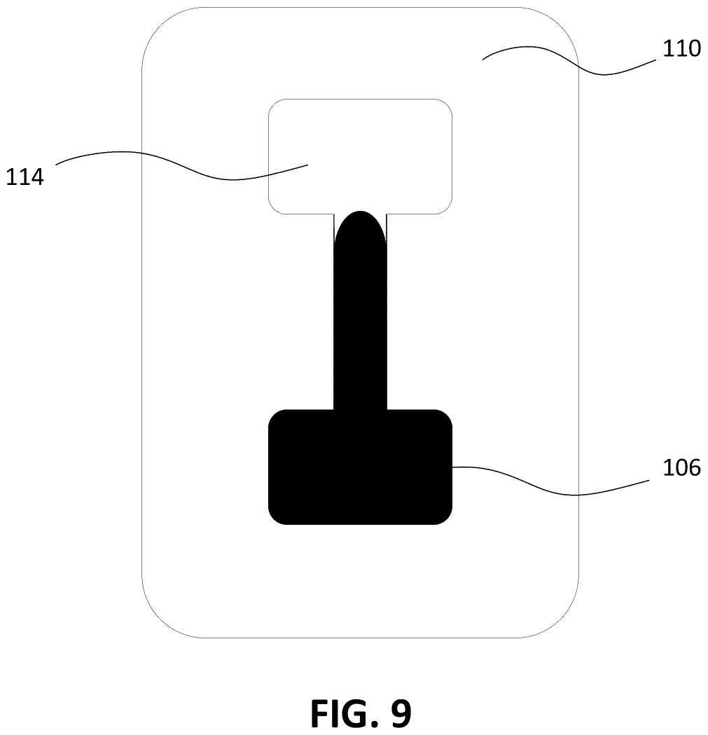

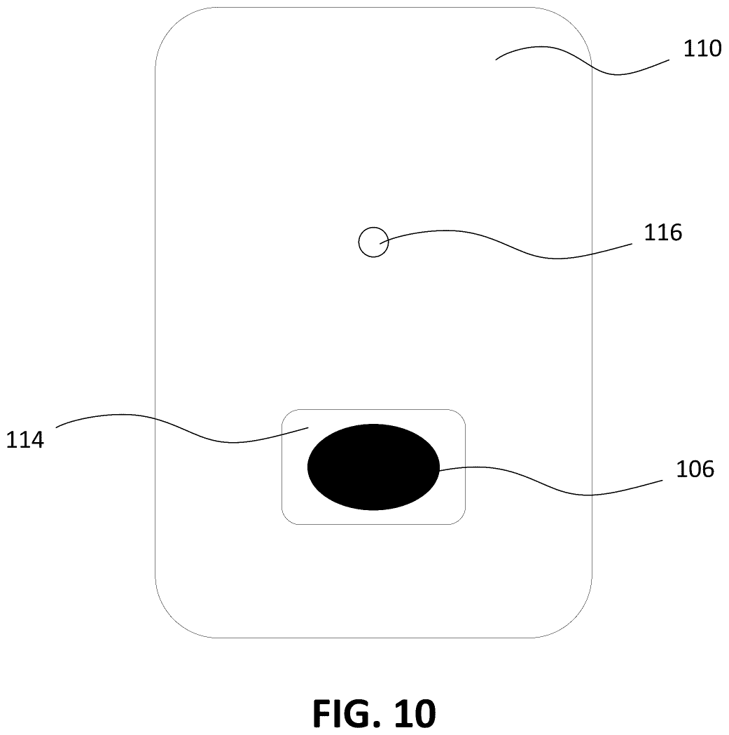

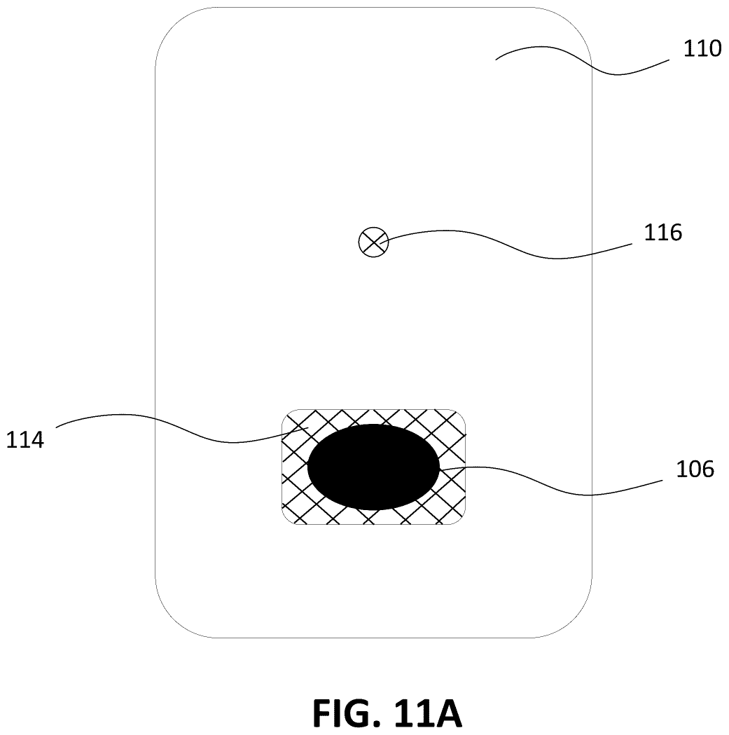

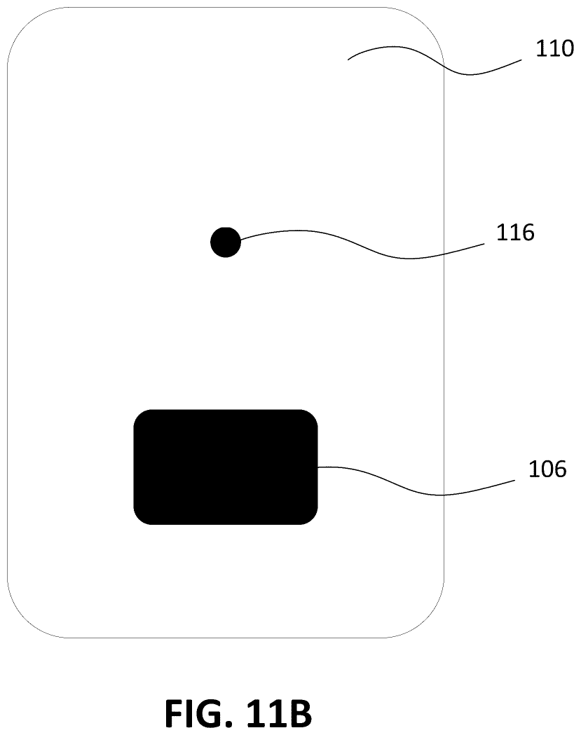

In one example, the activatable indicator may include a substrate 102, a wick 114 supported by the substrate 102 and microcapsules 104 containing an environmental indicator material 106 supported by the substrate. When the activatable indicator is initially provided, the environmental indicator material 106 comprises a solid indicator material, e.g., a mixture of a synthetic polymeric material and a wax material. The microcapsules 104 are configured to respond to an activation heat, an activation pressure, or a combination of an activation heat and activation pressure by fracturing, melting, breaking, dissolving, or becoming porous. This response releases the environmental indicator material 106 from the microcapsules 104. In FIG. 7, the unactivated microcapsules 104 containing the environmental indicator material 106 lay atop the wick 114 (e.g., one end of the wick 114). After the microcapsules 104 are activated, the released environmental indicator material 106 may begin to migrate along the wick 114 as shown in FIG. 8A. Alternatively, the released environmental indicator material 106 may be formulated to remain where the microcapsules are disposed (e.g., at an end of the wick 114) until or unless the released environmental indicator material 106 is exposed to the predetermined environmental stimulus at which time the released environmental indicator material can migrate along the wick 114, e.g., while they remain at a temperature below the melting of the environmental indicator material, or a temperature above which the environmental indicator material wicks freely with a reduced viscosity. After a given period of time, the environmental indicator material 106 may sufficiently migrate along the wick 114 such that the wick 114 is mostly covered in the environmental indicator material 106 as shown in FIG. 9. In embodiments with a top viewing layer 110, the distance the environmental indicator material 106 migrates along the wick may correspond to a viewing window 116 within the top viewing layer 110. FIG. 10 shows an unactivated activatable environmental sensor print medium 100 which can be seen by a lack of environmental indicator material 106 in the viewing window 116, whereas FIG. 11B shows an activated activatable environmental sensor print medium 100 having been exposed to a predetermined environmental stimulus, e.g., to a temperature above the melting point of the environmental indicator material. By the use of a wick, a user may optically determine whether an activation event has occurred and whether the environmental indicator material 106 has been exposed to a predetermined environmental stimulus.

The environmental indicator material 106 provides an indication of the exposure of the activatable environmental sensor print medium 100 to a predetermined environmental stimulus and/or provides an indication of duration of time elapsed since an activation event. In their initial non-activated configuration such as that shown in FIG. 4. The microcapsules 104 may prevent the environmental indicator material 106 from operating to provide the indication of exposure to the predetermined environmental stimulus, e.g. by preventing an environmental indicator material state change (e.g., by separating two materials that would otherwise interact, by keeping the environmental indicator materials from being exposed to the relevant predetermined environmental stimulus, or by preventing movement, flow, or wicking of the indicator material after it changes to a mobile state, such as a liquid, or by hiding the indicator material (if the microcapsules were opaque and the indicator material color changes in response to environmental exposure).

Upon activation, the microcapsules 104 are ruptured, and the environmental indicator material 106 is exposed to the environment and thus is able to respond to the predetermined environmental stimulus when it occurs. As one such example, FIG. 4 illustrates an environmental indicator material 106 contained within microcapsules 104 prior to an activation event. FIG. 5 illustrates the environmental indicator material 106 having been released from the microcapsules 104 following an activation event. In this example, the microcapsules 104 have been ruptured from exposure to an activation pressure or an activation heat.

The environmental indicator material 106 is configured to melt at a predetermined threshold temperature, and then move along the wick 114 when melted. The melted material is chosen so that it takes a predetermined amount of time to move along the wick 114 at or about the predetermined threshold temperature, and so that the indicator changes indicator state at the predetermined amount of time.

The predetermined threshold temperature may be chosen at any suitable range depending on the applications. For example ranges may be chosen to show whether a product has been removed from a freezer, or a refrigerator, or exposed to another higher temperature. Example predetermined threshold temperatures may be about −10° C. to about 80° C., and preferably from about 0° C. to about 70° C., from about 0° C. to about 60° C., from about 1° C. to about 30° C., from about 2° C. to about 20° C., from about 5° C. to about 15° C., from about 8° C. to about 12° C., from about 9° C. to about 11° C., e.g., about 10° C., from about 0° C. to 150° C., from about 0° C. to 50° C., from about 50° C. to 100° C., from about 90° C. to 110° C., from about 100° C. to 150° C., from about 100° C. to 200° C. It will be appreciated that the activation heat ranges given are purely exemplary and other ranges may be known to an artisan practicing ordinary skill in the art. A predetermined threshold temperature around 10° C. may be used to show removal from refrigeration. The wick 114 and the environmental indicator material 106 are configured so that exposure to at least the predetermined threshold temperature for at least a predetermined exposure time results in at least a predetermined amount of movement of the environmental indicator material 106 along the wick 114.

In some cases, pressure may also contribute to the activation, e.g., by breaking microcapsules 104, either alone like an impact printer, or in combination with elevated temperature. In some examples, the activation pressure required to activate the microcapsules 104 may be from about 1.5 to 8 pounds per square inch or from about 4 to 15 pounds per square inch. It will be appreciated that the activation pressure ranges given are purely exemplary and other ranges may be known to an artisan practicing ordinary skill in the art.

The environmental indicator material 106 may include a synthetic polymeric material, e.g., a polymer having side chain crystallinity (SCC). Two or more SCC polymers may be blended in order to tune the properties of the material. In an example embodiment, the polymer having side chain crystallinity (SCC) is a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms. Examples of such synthetic polymeric material are described in detail in U.S. Pat. Nos. 9,546,911 and 8,671,871, which are fully incorporated herein by reference for all purposes.

The synthetic SCC polymer may be selected so that it is solid at or below the stop temperature and is, or can become, a viscous liquid when at or above the predetermined threshold temperature. Such synthetic SCC polymer is meltable, and can also be hydrophobic, if desired. The synthetic SCC polymer may have a molecular weight of at least about 1,000 Da. In an example embodiment, the synthetic SCC polymer can have desirably sharp transitions from a solid state to a liquid state. When the indicator returns to a temperature at or below the stop temperature, the material may re-solidify, and thus stop moving.

The wax material may be at least one of an alkane wax, an alkyl ester, a natural wax, or a modified natural wax. In an example embodiment, the wax material comprises at least one of an undecane, a dodecane, a tridecane, a tetradecane, a pentadecane, a hexadecane, a heptadecane, an octadecane, a nonadecane, an eicosane, a heneicosane, a hexanoic acid, ethyl lactate, a paraffin wax, a microcrystalline wax, carnauba wax, beeswax, Chinese wax, shellac wax, spermaceti, tallow, palm wax, soy wax, 15 lanolin, wool grease, a waxy polymer, a waxy copolymer, a polyolefin, polyethylene, polypropylene, an ethylene-vinyl acetate copolymer, an ethylene-acrylic acid copolymer, and combinations thereof. In some disclosed examples the wax material is a blend of two alkane waxes. For example, the wax material may be a blend of hexadecane and pentadecane in a weight ratio of hexadecane to pentadecane from about 40:60 to about 1:95, from about 30:70 to about 10:90, from about 20:80 to about 10:90, or more preferably about 15:85. Other ranges may be chosen to tune the properties of the material. It will be appreciated that other combinations and proportions may also be employed. While other materials with the similar melting and flow properties as these wax materials might be employed, waxes like those disclosed herein generally tend to be stable, safe, have low volatility, and are easy to use in the manufacturing process.

In an example embodiment, a ratio of the synthetic polymeric material to the wax material is in a range from about 10:90 to about 90:10, from about 20:80 to about 80:20, from about 30:70 to about 70:30, from about 40:60 to about 60:40, from about 50:50 to about 60:40 and preferably from about 52:48 to about 58:42, e.g., about 55:45.

In an example embodiment, the predetermined exposure time for the environmental indicator material 106 to reach the predetermined amount of movement along the transport element (e.g., the wick 114) at the predetermined threshold temperature is in a range of about 0.1-48 hours or even up to 72 hours or longer, about 1-24 hours, about 2-15 hours, about 2-10 hours, about 3-9 hours, or about 4-8 hours.

In an example embodiment, the predetermined threshold temperature is about 10° C., which corresponds to removal from a typical refrigerator unit, and the predetermined exposure time for the environmental indicator material 106 to reach the predetermined amount of movement along the transport element at the predetermined threshold temperature is in a range of about 4-8 hours. Other thresholds may be chosen, depending on the properties of the materials or host products being monitored and particular applications.

Atop the substrate 102, microcapsules 104, environmental indicator material 106, and wick 114, may be a clear overlaminate film 108. The clear overlaminate film 108 is an overlay component overlaying the substrate 102 and microcapsules 104. The overlaminate film 108 may be one of Fasson Faslam clear polypropylene, Avery Dennison® DOL series vinyl (PVC), any conformable overlaminate films, Apco PET or BOPP overlaminate films. The clear overlaminate film 108 allows a user to view through the clear overlaminate film 108 to see the layers below including the substrate 102 and microcapsules 104 while isolating and/or protecting the layers such that the layers (e.g., the substrate 102 and microcapsules 104 can be seen, but not touched. Depending on the desired application, the clear overlaminate film 108 may optionally be UV, blocking, water resistant, hermetically sealed, chemically resistant, or merely a barrier to physical abrasion.

Finally, in some embodiments, a top viewing layer 110 may be placed atop the clear overlaminate film 108. The top viewing layer 110 may be any material suitable for displaying the microcapsules 104 and environmental indicator material 106, e.g., porous materials for bar codes printed using inks, etchable materials for laser-etched bar codes, paper, nylon, vinyl, other synthetic polymers such as polytetrafluoroethylene (“PTFE”), or other materials that are suitable for receiving and displaying the microcapsules 104 and environmental indicator material 106. The top viewing layer 110 may, for example, be paper or film (e.g., nylon, vinyl, synthetic polymer material, carbon fiber, Teslin synthetic paper, polyethylene (“PE”), polypropylene (“PP”), polytetrafluoroethylene (“PTFE”), polyester, polyethylene, polyolefin, polyimide, vinyl, acrylic film, polypropylene, non-woven nylon, coated and non-coated direct thermal paper, printable polyethylene terephthalate (“PET”), oriented polypropylene (“OPP”), biaxially oriented polypropylene (“BOPP”). Additionally, the top viewing layer may include holes or viewing windows 116.

### Example Humidity Indicator

In another example, the microcapsules 104 may be used in an activatable material. A humidity sensitive material, e.g., a hygroscopic or hydrophilic material, can be encapsulated in a moisture resistant microcapsule. Example indicator materials for the indicator may include hydrochromic inks, polar protic solvents, polar pigments, and/or polar polymers. Example materials for the shell may include a gel, gelatin, protein, polyurea formaldehyde, polymelamine formaldehyde, wax material, melamine, or an emulsion. The shell materials may also be hydrophilic.

The microcapsules 104 itself responds when it reaches a temperature of in a range from about 0° C. to 150° C., from about 0° C. to 50° C., from about 50° C. to 100° C., from about 90° C. to 110° C., from about 100° C. to 150° C., from about 100° C. to 200° C., from about 200° C. to 300° C. It will be appreciated that the activation heat ranges given are purely exemplary and other ranges may be known to an artisan practicing ordinary skill in the art. In some cases, pressure may also contribute to the activation, e.g., by breaking microcapsules 104, either alone like an impact printer, or in combination with elevated temperature. In some examples, the activation pressure required to activate the microcapsules 104 may be from about 1.5 to 8 pounds per square inch or from about 4 to 15 pounds per square inch. It will be appreciated that the activation pressure ranges given are purely exemplary and other ranges may be known to an artisan practicing ordinary skill in the art.

### Example Cumulative Heat Exposure Indicator

In another example, the microcapsules 104 may be used in an activatable cumulative heat exposure indicator. For example, modifications may be made to the cumulative heat exposure indicator of U.S. Pat. No. 9,011,794 of Freshpoint Quality Assurance Ltd. This indicator relies on etching of a metal substrate by phosphoric acid or other etchant material. The rate of etching is sensitive to temperature and provides an indication of cumulative temperature exposure. For example, etching of the metal layer with the etchant can cause a change, e.g., in an optical property (absorption, transmission, reflectivity, color, hue, etc.) of the cumulative heat exposure indicator and/or in an electrical property (conductivity/resistance, capacitance, etc.) of the cumulative heat exposure indicator. However, by encapsulating the phosphoric acid or other etchant in microcapsules (e.g., as the environmental indicator material 106 in the microcapsules 104), the microcapsules can be disposed on the metal substrate and etchant encapsulated in the microcapsules will not etch the metal substrate until the microcapsules are placed in the activated configuration to release etchant and after the released etchant onto the metal substrate and the released etchant is subsequently exposed a predetermined environmental stimulus (e.g., temperatures above a response temperature of the environmental indicator material). Using this approach, the cumulative heat exposure indicator including the microcapsules disposed on the metal substrate can be stored at temperatures above the response temperature without causing a detectable response while in the non-activated configuration, and after the microcapsules are ruptured, releasing the etchant, in response to an activation event, the indicator can operate normally (e.g., be responsive to temperature to produce a detectable response in response to etching of the metal substrate). The microcapsules 104 may be any material that inhibits wicking prior to activation that does not have an affinity for the dye or wax. In this manner an improved cumulative heat exposure indicator may be provided.

### Example Time-Temperature Indicator

FIGS. 7-12 show an example indicator based on the Zebra/Temptime Limitmarker D-A time-temperature exposure indicator. The indicator material used is a solvent based SCC with an Alkane Wax blend combined with a colored dye, similar to U.S. Patent Publication 20220178761 applied for by Temptime Corporation, a Zebra Technologies company. FIGS. 7-9 show the internals of the indicator prior to the addition of the top viewing layer 110. FIG. 10 shows the same indicator with the top viewing layer 110—the viewing window 116, white dot indicates a temperature excursion has not occurred. FIGS. 8-9 show the internals of the same indicator after exposure to excess temperature for two different periods of time. FIG. 8A shows the internals of the same indicator soon after exposure to excess temperature, whereas FIG. 9 shows the internals of the same indicator after a longer period of time since the exposure to excess temperature than FIG. 8A. The environmental indicator material 106 melts and transits the wick 114 carrying the colored dye with it. With the top viewing layer 110 on in FIG. 11B, the viewing window 116 appears in a color different from than the initial color shown in FIG. 10, such as red, showing to a user that the indicator has been exposed to excess temperature for more than the minimum time. It will be appreciated that the colors white and red are purely exemplary and other color combinations may be used in the indicator to signify exposure. FIG. 8B shows an alternative embodiment where at least some of the microcapsules 104 contain an activation indicator material, e.g., a dye of a different color than the dye described above and that freely diffuses at a lower temperature than the environmental indicator material. When the microcapsules 104 are ruptured, this material quickly diffuses along the wick changing the color of the indicator. For example, if the environmental indicator material normally carries a black dye, a yellow dye with a much lower melting temperature may also be included. This material may then rapidly diffuse turning the indicator 116 yellow, which would then be a sign that the device had actually been activated. FIG. 11A shows the appearance of this indicator when it is has been activated, with the top cover on the device.

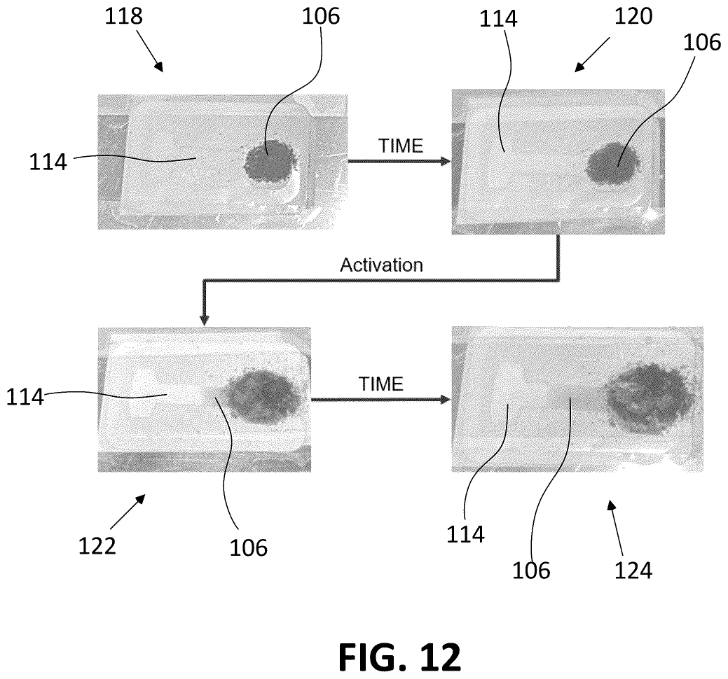

FIG. 12 shows the example indicator in several phases before activation and phases when exposed over time to a temperature above the melting point of the indicator material for an extended time. 118 illustrates an example indicator before an activation event. This structure is the internal structure similar to the Limitmarker D-A indicator mentioned above, without the covering material. As can be seen from the photo, the environmental indicator material 106 is contained in the reservoir and does not migrate. 120 shows the same indicator after activation by exposure to heat and pressure sufficient to rupture the microcapsules 104. When the environmental indicator material 106 is exposed to the same temperature as in FIG. 1, the environmental indicator material 106 melts and migrates along the wick 114, which will produce an observable indication of a temperature exposure in the Limitmarker indicator design. After yet more time, the environmental indicator material 106 will continue to further migrate along the wick 114 as shown in 122. Finally, the environmental indicator material 106 will reach a sufficient distance along the wick 114 such as in 124 that the observable indication of temperature exposure can be seen even with a top viewing layer 110 adhered to the indicator.

### Activation Methods

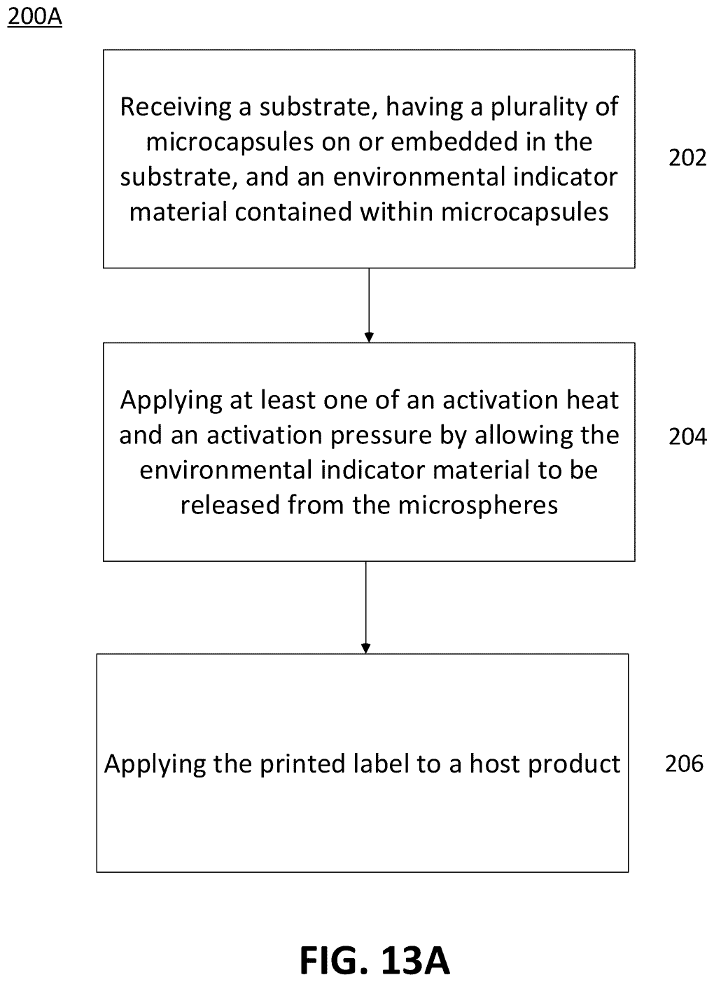

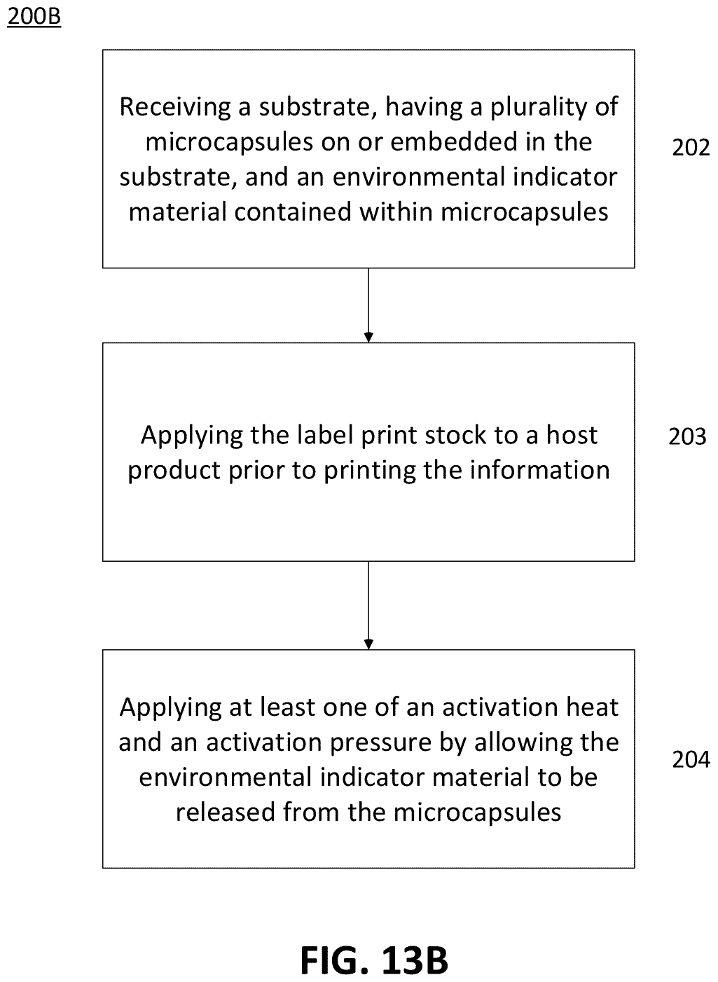

An example procedure 200A for activating an activatable environmental sensor print medium (e.g., the activatable environmental sensor print medium 100) is disclosed herein and shown in FIG. 13A. In 202, a substrate (e.g., the substrate 102) having microcapsules (e.g., the microcapsules 104) on or embedded in the substrate and an environmental indicator material (e.g., the environmental indicator material 106) contained within the microcapsules is received. For example, this may be any of the examples described previously in the present disclosure, e.g., the examples shown in FIGS. 7-12. In 204, while the indicator is printed, an activation heat and/or an activation pressure is applied which ruptures the microcapsules, allowing the environmental indicator material 106 to be released from the microcapsules. Upon release from the microcapsules 104, the environmental indicator material 106 is configured to respond to exposure to a predetermined environmental stimulus by causing a detectable response. In some embodiments, in 206 the printed label may be applied to a host product or its package, e.g., using an adhesive on the label or a separately applied adhesive.

An alternative example procedure 200B for activation is shown in FIG. 13B. In 202, a substrate (e.g., the substrate 102) having microcapsules (e.g., the microcapsules 104) on or embedded in the substrate and an environmental indicator material (e.g., the environmental indicator material 106) contained within the microcapsules is received. The substrate may be printed without activating the indicator, e.g., by printing at a lower temperature and/or with less pressure than is required to materially affect the microspheres. Optionally, in 203, the printed substrate may be applied to a host product or to a package without activation of the microcapsules. At a later time, at least one of an activation heat and/or an activation pressure, which is greater than the printing temperature and/or pressure is applied which ruptures the microspheres and allows the environmental indicator material to be released from the microcapsules. This may be accomplished, for example, using the same printer device as was used for printing but with a different temperature setting, or may be accomplished using a different device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental sensor print medium, comprising:
a substrate;
an environmental indicator material configured to respond to a predetermined environmental stimulus; and
a plurality of microcapsules on or embedded in the substrate, containing the environmental indicator material, wherein:
the microcapsules are configured to respond to at least one of an activation heat and an activation pressure by allowing the environmental indicator material to be released from the microcapsules, and
the environmental indicator material, after being released from the microcapsules, is configured to respond to exposure to the predetermined environmental stimulus by causing a detectable response.

2. The activatable environmental sensor print medium of claim 1, further comprising an activation indicator material provided in at least a subset of the microcapsules that causes a change of appearance of the activatable environmental sensor print medium when the environmental indicator material is released from the microcapsules.

3. The activatable environmental sensor print medium of claim 1, wherein the detectable response is selected from a group consisting of a color state change, a change in transparency, a change in hue, a change in an electrical property, a change in conductivity, a change in capacitance, movement of the environmental indicator material along the substrate, and combinations thereof.

4. The activatable environmental sensor print medium of claim 3, wherein the environmental indicator material is configured to respond to exposure to the predetermined environmental stimulus by migrating along the substrate.

5. The activatable environmental sensor print medium of claim 4, wherein the environmental indicator material further comprises a meltable solid configured to melt in response to a predetermined temperature above a threshold, forming a liquid that migrates along the substrate for at least a predetermined distance when remaining at a temperature above the threshold for at least a predetermined time period.

6. The activatable environmental sensor print medium of claim 5, wherein the environmental indicator material further includes a colorant that migrates together with the liquid.

7. The activatable environmental sensor print medium of claim 6, further comprising an activation indicator material provided in at least a subset of the microcapsules that causes a change of appearance of the activatable environmental sensor print medium when the environmental indicator material is released from the microcapsules, the activation indicator material including a second colorant that is visually distinguishable from the colorant.

8. The activatable environmental sensor print medium of claim 7, further comprising a wick on or in the substrate, and positioned to allow the released environmental indicator material and the colorant to migrate along the wick.

9. The activatable environmental sensor print medium of claim 4, wherein the environmental indicator material comprises a gel configured to, in response to a predetermined temperature above a threshold, change viscosity causing the gel to migrate along the substrate for at least a predetermined distance when remaining at a temperature above the threshold for at least a predetermined time period.

10. The activatable environmental sensor print medium of claim 9, wherein the environmental indicator material further includes a colorant that migrates together with the gel.

11. The activatable environmental sensor print medium of claim 10, further comprising a wick on or in the substrate, and positioned to allow the released environmental indicator material and the colorant to migrate along the wick.

12. The activatable environmental sensor print medium of claim 1, wherein the microcapsules are configured to respond to the activation heat and the activation pressure provided by a direct thermal print head.

13. The activatable environmental sensor print medium of claim 1, wherein the activation heat is between 90° C. and 110° C.

14. The activatable environmental sensor print medium of claim 1, wherein the activation pressure is between 1.5 to 8 pounds per inch.

15. The activatable environmental sensor print medium of claim 1, wherein the activation heat is between 100° C. and 200° C. and the activation pressure is between 4 to 15 pounds per inch.

16. The activatable environmental sensor print medium of claim 1, wherein the predetermined environmental stimulus is chosen from a list consisting of temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

17. The activatable environmental sensor print medium of claim 1, wherein the environmental indicator material comprises an alkane wax polymer having side-chain crystallinity.

18. (canceled)

19. The activatable environmental sensor print medium of claim 1, wherein the microcapsules are selected from a group consisting of a gel, a protein, a wax material, emulsions, polyurea formaldehyde, polymelamine formaldehyde, and combinations thereof.

20-24. (canceled)

25. The activatable environmental sensor print medium of claim 1, wherein the microcapsules have an outer diameter length between 20 to 250 μm.

26. The activatable environmental sensor print medium of claim 1, where the microcapsules respond by fracturing, melting, breaking, dissolving, or becoming porous.

27-29. (canceled)

30. An activatable environmental sensor print medium, comprising:
a substrate;
an environmental indicator material configured to respond to a predetermined environmental stimulus; and
a plurality of microcapsules on or embedded in the substrate, containing the environmental indicator material, wherein:
the microcapsules are configured to respond to at least one of an activation heat and an activation pressure by allowing the environmental indicator material to be released from the microcapsules, and
the environmental indicator material, after being released from the microcapsules, is configured to migrate along the substrate in response to exposure to the predetermined environmental stimulus by causing a detectable response.

27-58. (canceled)

59. A method of activating an environmental sensor print medium, comprising:
receiving a substrate, having a plurality of microcapsules on or embedded in the substrate, and an environmental indicator material contained within microcapsules; and
applying at least one of an activation heat and an activation pressure by allowing the environmental indicator material to be released from the microcapsules, wherein:
the microcapsules are configured to respond to at least one of an activation heat and an activation pressure by allowing the environmental indicator material to be released from the microcapsules, and
the environmental indicator material, after being released from the microcapsules, is configured to respond to exposure to a predetermined environmental stimulus by causing a detectable response.

60-66. (canceled)
